(19) United States
(12) Patent Application Publication
(10) Pub. No.: US 2004/0185231 A1
(43) Pub. Date: Sep. 23, 2004

(54) Polymer coated surfaces having inlaid decorative sheets

(76) Inventor: William Joseph Dimmick, Crystal Lake, IL (US)

Correspondence Address: Mark D. Swanson, Pauley Petersen Kinne & Erickson, Suite 365, 2800 West Higgins Road, Hoffman Estates, IL, 60195, US

(21) Appl. No.: 10/376,429

(22) Filed: Feb. 28, 2003

(51) Int. Cl. B32B 7/00; B32B 3/00

(52) U.S. Cl. 428/195.1

(57) ABSTRACT

A coated substrate surface, for example a concrete floor, including a polymer base coat bonded to the surface of the substrate. A printed sheet is bonded to a side of the polymer base coat opposite the surface of the substrate. A polymer top coat is bonded to a side of the printed sheet opposite the polymer base coat. The printed sheet is visible through the polymer top coat. The substrate surface can be coated by applying a polymer base coat and an adhesive layer to the substrate surface. The polymer base coat includes a pigmented polymer material applied to the substrate and cured. An adhesive layer is applied on at least a portion of the cured polymer base coat and at least one printed sheet is placed on at least a portion of the adhesive layer. A polymer top coat including at least one liquid polymer top coat layer is applied on the at least one printed sheet and cured.

### FIELD OF INVENTION

The present invention relates to polymer coating materials for coating surfaces of a substrate by forming a monolithic bond with the substrate surface. More particularly, the invention relates to multi-layer polymer material based coatings for substrate surfaces, the polymer material based coatings having at least one inlaid decorative printed sheet that is visible through a polymer material coating.

### BACKGROUND OF THE INVENTION

This invention relates generally to polymer coatings, such as epoxy, polyurea, or polyurethane coatings, for substrate surfaces. General polymer surface coating systems are known for use on surfaces such as floors, walls, and ceilings in places such as warehouses, factories and other industrial settings, commercial or retail settings, recreational settings, basements, airplane hangers, and garages. The coatings are generally applied as a liquid polymer material and cured to bond with the substrate surface. The polymer coating can impart water, chemical, and slip resistance to the substrate surface, thereby protecting the surface and increasing longevity.

Although known polymer surface coating systems are desirable for surface protection, they generally have limited decorative effect. The polymer coatings can be pigmented or have small colored plastic flakes spread over and into the polymer material before curing. There is a need for a polymer flooring system that provides a customized decorative look. There is a need for a polymer flooring system that allows for pictures, logos, or other designs to be inlaid in a multi-layered polymer surface coating.

### SUMMARY OF THE INVENTION

A general object of the invention is to provide an improved polymer surface coating having an inlaid printed sheet. The general object of the invention can be attained, at least in part, through a method of coating a substrate surface including applying a polymer base coat, also referred to as a polymer primer layer, on the substrate surface, placing a printed sheet on at least a portion of the base coat, and applying a polymer top coat on the printed sheet. The polymer base coat and polymer top coat are both applied as at least one liquid polymer layer, which are subsequently cured to form a monolithic bond with the substrate surface. The printed sheet is visible through the polymer top coat.

The invention further comprehends a method of coating a substrate surface including applying a liquid polymer base coat, or primer layer, to the substrate surface and curing the polymer base coat. The polymer base coat can include a pigmented polymer material. An adhesive layer is applied on at least a portion of the cured polymer base coat, and at least one printed sheet is placed on at least a portion of the adhesive layer. A polymer top coat including at least one liquid polymer top coat layer is applied on the at least one printed sheet. The at least one liquid polymer top coat layer is cured and the at least one printed sheet is visible through the polymer top coat. In one embodiment of this invention, the polymer base coat is not pigmented

The invention provides a multi-layered surface such as a multi-layered floor. The multi-layered floor includes a floor substrate having a surface and a polymer base coat bonded to the surface of the floor substrate. A printed sheet is bonded to a side of the polymer base coat opposite the surface of the floor substrate. A polymer top coat is bonded to a side of the printed sheet opposite the polymer base coat. The printed sheet is visible through the polymer top coat. The printed sheet can include various materials and have various designs or pictures printed thereon by methods known in the art. The multi-layered coatings of this invention can provide protection and/or structural reinforcement to a substrate, such as a floor, as well as a decorative feature, such as a corporate logo inlaid in a warehouse or showroom floor. The decorative features provided by this invention can be used in the settings described above, as well as other places, such as retail stores, museums, and office buildings.

Other objects and advantages will be apparent to those skilled in the art from the following detailed description taken in conjunction with the appended claims and drawings.

### BRIEF DESCRIPTION OF THE DRAWINGS

These and other objects and features of this invention will be better understood from the following detailed description taken in conjunction with the drawings, wherein:

FIG. 1 is a cross-sectional view of a coated substrate according to an embodiment of this invention.

FIG. 2 is a top view of a coated floor according to another embodiment of this invention.

FIG. 3 is a cross-sectional view of a coated floor taken along line 3-3 in FIG. 2.

### DESCRIPTION OF PREFERRED EMBODIMENTS

The present invention provides coated substrate surfaces and methods for coating substrate surfaces. The coatings of this invention provide a protective and decorative coating to various substrate surfaces. More particularly, the invention relates to coating floors, walls, and ceilings including concrete, wood, tile, metal, fiberglass, gypsum board, and drywall. The coatings of this invention include at least one printed sheet that is visible through a polymer top coat.

In one embodiment of this invention, a method of coating a substrate surface includes applying a polymer base coat on the substrate surface, placing a printed sheet on at least a portion of the base coat, and applying a polymer top coat on the printed sheet. The substrate can include various substrate materials, such as described above. The “Polymer base coat” or “polymer primer layer” refers to one or more layers, or applications, of a polymer material applied between the printed sheet and the substrate surface. The polymer base coat includes a polymer material that will seal, repair, and/or smooth or level a substrate surface, thereby providing a strong bond between the substrate surface and the coatings of this invention. The polymer base coat is applied as one or more liquid polymer material layers which are cured after application, and desirably before application of a subsequent layer of polymer material. The polymer base coat can be fully cured either before or after placement of the printed sheet. As will be appreciated by one skilled in the art, the polymer base coat can include various polymers materials which can be neat polymer materials or aggregate filled polymer materials. Examples of polymer materials useful in the one or more layers of the polymer base coat of this invention include epoxies, polyureas, urethanes, acrylics, styrene-butadienes, polyvinyl acetates, chlorinated rubbers, polyesters, methacrylates, and combinations thereof. The polymer base coat can be pigmented and is desirably ultraviolet radiation resistant, particularly for interior or exterior applications where ultraviolet radiation exposure is encountered. Ultraviolet radiation resistance can be achieved by using an ultraviolet radiation resistance polymer material or through additives such as ultraviolet absorbers and/or hindered amines.

The substrate coatings of this invention include a printed sheet that is visible through the polymer top coat. The printed sheet provides a decorative feature to the coated substrate surface. The printed sheet can cover the whole substrate surface or a portion of the substrate surface. In addition, more than one printed sheet can be placed in predetermined places on the polymer base coat according to the desired design of the finished coated substrate surface. If the desired design is too large to be printed on one sheet, more than one printed sheet can be properly aligned on the polymer base coat.

The printed sheet can include various sheet materials such as natural fiber sheets including cotton, silk, and canvass materials, synthetic fiber sheets including nylon or other nonwoven thermoplastic fibrous sheets, vinyl sheets, fiberglass sheets, metal sheets, plastic sheets, paper sheets, epoxy glass grid sheets, carbon fiber grids or sheets, and combinations of these sheets. The printed sheet can be printed with any colors or images to provide the desired decorative effect. The printed sheet can include corporate or organization logos, identification of and/or directions to emergency exits, safety warnings or information, or holographic images. As will be appreciated by one skilled in the art, the printing of the sheet material can be accomplished by various means known in the printing arts, depending on the sheet material and desired image to be printed. Scanning photos into a computer or drawing using a computer and using a color printer are examples of suitable printing methods.

The printed sheet is placed on the polymer base coat either before or after the polymer base coat is cured. Placing the printed sheet on the polymer base coat before the polymer base coat is cured, or at least fully cured, followed by fully curing the polymer base coat can secure the printed sheet to the polymer base coat. In one embodiment of this invention, the printed sheet is perforated or woven. The perforated or woven printed sheet can be placed on the uncured polymer base coat and when a small amount of pressure is placed on the printed sheet the polymer base coat will form a monolithic bond through the perforations or between and around at least some of the fibers of the printed sheet.

The printed sheet can also be placed on a fully cured polymer base coat. Desirably an adhesive material, applied either as a full layer over a cured polymer base coat or in predetermined isolated locations such as only under the printed sheet, can be applied to the cured polymer base coat to secure the printed sheet. The adhesive layer can include various adhesive materials known in the art. Examples of useful adhesives include polymer material adhesives such epoxies, polyureas, urethanes, acrylics, styrene-butadienes, polyvinyl acetates, chlorinated rubbers, polyesters, methacrylates, and combinations thereof. Also, more than one layer of sheet can be placed on the polymer base coat. In one embodiment of this invention, the method of coating a substrate surface includes placing a first sheet on at least a portion of the adhesive layer, applying a second adhesive layer on the first sheet, and placing a second sheet on the second adhesive layer. At least one of the first and second sheets is a printed sheet.

A polymer top coat is applied over the printed sheet. The polymer top coat can include one or more layers, or applications, of a polymer material. The printed sheet is visible through the polymer top coat, thereby providing a decorative feature to the coated substrate surface. In one embodiment of this invention, the top coat can have a high gloss or satin finish. The polymer top coat can be pigmented by a colorant to obtain a colored tint and the polymer top coat desirably includes an ultraviolet radiation resistant polymer material. The polymer top coat can have a high gloss or satin finish. The polymer top coat can be applied as one or more liquid layers which are cured, desirably before application of the next liquid layer. The polymer top coat can include one or more layers of various polymer materials and combinations known in the art, such as epoxies, polyureas, urethanes, acrylics, styrene-butadienes, polyvinyl acetates, chlorinated rubbers, polyesters, methacrylates, and combinations of these polymer materials.

In one embodiment of this invention, the polymer base coat is a polymer primer layer on the substrate surface. The polymer primer layer includes a polymer material, such as an epoxy, polyurea, urethane, acrylic, styrene-butadiene, polyvinyl acetate, chlorinated rubber, polyester, methacrylate, and combinations of these polymer materials. The polymer primer layer is applied as a liquid and subsequently cured forming a monolithic bond with the substrate surface. The polymer primer layer can be pigmented by use of a colorant material and can be ultraviolet radiation resistant. In another embodiment of this invention, a pigmented polymer layer, including a same or different polymer material or materials as the polymer primer layer and a pigment can be applied to the cured polymer primer layer as a liquid and cured.

An adhesive layer is applied to at least a portion of the cured polymer primer layer or, when included, the cured pigmented polymer layer. The adhesive layer can be applied to the cured polymer primer layer or the cured pigmented polymer layer on the cured polymer primer layer. The adhesive layer includes an adhesive material that adheres the printed sheet to the polymer base coat. The adhesive material can be any adhesive known in the art, including a polymer adhesive such as epoxies, polyureas, urethanes, acrylics, styrene-butadienes, polyvinyl acetates, chlorinated rubbers, polyesters, methacrylates, and combinations thereof. The printed sheet is then placed on at least a portion of the adhesive layer. Desirably the adhesive layer is applied to cover only the same area as the printed sheet. The printed sheet can include any of the printed sheets described herein.

A polymer top coat is then applied over the printed sheet, and desirably over the entire substrate surface covered by the polymer base coat including the printed sheet. The at least one printed sheet is visible through the polymer top coat, thereby providing a decorative feature to the substrate surface. The polymer top coat includes at least one polymer top coat layer, including any of the polymer materials described above, applied as a liquid and cured. Desirably, each liquid polymer top coat layer is cured before application of any additional polymer top coat layer.

As will be appreciated by one skilled in the art, the substrate and/or the substrate surface may require preparation before applying the surface coatings according to this invention. The substrate surface should be in good repair, free of cracks, holes, or other surface irregularities. Desirably the substrate surface will be flat and not have irregular surface grades or low spots (puddle areas). The substrate surface can be repaired by means known in the art before coating according to this invention. Concrete floors, for example, can be repaired using materials such as concreter, polymer concrete, epoxies, methacrylates, urethanes, polyesters, polyureas, neoprenes, asphaltic, and mixed polymer formulas. The polymer base coat, or polymer primer layer, can be applied to repair and/or smooth or level the substrate surface. The substrate surface should also be clean and free of oil or other surface or penetrating contaminants. Cleaning techniques and materials, appropriate for various surfaces are known in the art. Concrete surfaces for example, such as concrete floors, can be cleaned using fatty acid emulsifier products, power washing, and/or abrasive blasting methods. Concrete floors can be tested to determine the cleanliness and the structural soundness by methods such as the Shear Cup Test Method or Tensile Pull Method known in the art.

The methods of this invention thus provide a coated substrate surface that has both decorative and functional features. The coatings of this invention can be used to provide abrasive, water, and/or chemical resistance as well as strengthen surfaces such as floors, walls, and ceilings. The coatings can include polymer base coats, printed sheets, and/or polymer top coats that are pigmented to provide the desired decorative effect. The printed sheet and the pigmented polymer base and top coats provide a functional and decorative alternative to known flooring systems. In addition, the polymer coatings of this invention can include other decorative accents, such as colored plastic or metallic flakes and/or glitter. Encapsulated lights can also be inlaid in the surface coatings of this invention to provide a decorative effect or for safety purposes, such as emergency lighting or directional lighting to emergency exits.

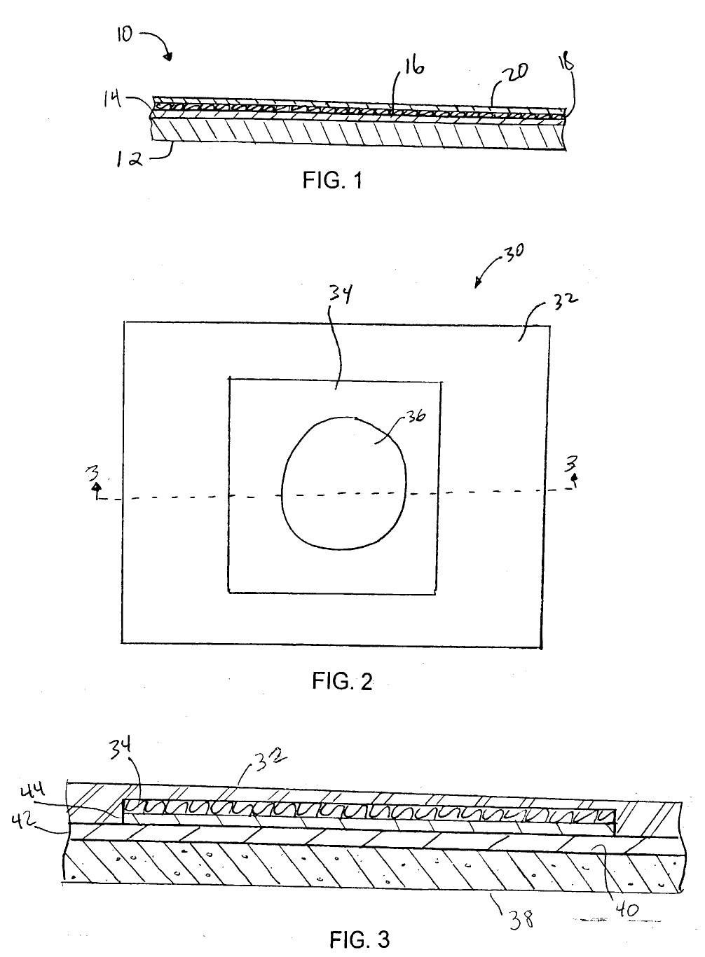

FIG. 1 shows a cross-sectional view of a coated substrate according to this invention. The coated substrate 10 includes a substrate 12, which could include any of the substrate materials described herein, such as concrete, wood, or metal. The substrate 12 has a surface 14 coated with a polymer base coat 16. The polymer base coat 12 is bonded to the surface 14. A printed sheet 18 is bonded to the polymer base coat 16 on a side opposite the substrate surface 14. A polymer top coat 20 is bonded to the printed sheet 18 on a side of the printed sheet 18 opposite the polymer base coat 16. If the printed sheet 18 is perforated or woven the polymer base coat 18 and the polymer top coat 20 could contact each other, and desirably bond together, through the printed sheet 18. The printed sheet 18 is visible through the polymer top coat 20. The polymer base coat 14, the printed sheet 16, and the polymer top coat 20 can include any of the embodiments described herein. For example, the polymer base coat 14 can include one or more polymer primer layers and an adhesive layer, or one or more polymer primer layers, a pigmented polymer layer, and an adhesive layer.

FIG. 2 shows a top view of a coated substrate according to another embodiment of this invention. FIG. 2 shows a coated concrete floor 30. The coated concrete floor 30 has a polymer top coat 32. Visible through the polymer top coat 32 is a printed sheet 34. The printed sheet 34 covers only a portion of the floor 30. The printed sheet 34 includes a design 36 printed on the printed sheet 34. The design 36 is also visible through the polymer top coat 32 and can include any printable or drawn design desired by the floor owner.

FIG. 3 is a cross-sectional view of the coated concrete floor 30 in FIG. 2 taken along line 3-3. FIG. 3 shows concrete floor 38 having floor surface 40. A polymer base coat 42 is bonded to the floor surface 40. The polymer base coat 42 can include any of the layers and materials described above. The printed sheet 34 is bonded to the polymer base coat 42 by an adhesive layer 44 on an opposite side of the floor surface 40. The polymer top coat 32 is bonded to the printed sheet 34 on an opposite side from the polymer base coat 42. As the printed sheet covers only a portion of the polymer base coat 42 and the floor surface 40, the polymer base coat 42 and the polymer top coat 34 bond directly to each other in the areas around the printed sheet 34. Also, if the printed sheet 34 is perforated or woven, the polymer base coat 42 and the polymer top coat 32 could contact each other, and desirably bond, through the printed sheet 34.

The polymer base coat 42 can include any of the polymer base coats described above, and can include one or more application layers of polymer materials. The polymer materials can be neat polymer materials and aggregate filled polymer materials, and can include polymers such as epoxies, polyureas, urethanes, acrylics, styrene-butadienes, polyvinyl acetates, chlorinated rubbers, polyesters, methacrylates, and combinations thereof. The polymer base coat 42 can have any thickness depending on the substrate, polymer material and need. In one embodiment, the polymer base coat 42 has a thickness of about 5 to 40 mils.

The polymer top coat 32 can include any of the polymer top coats described above and can include one or more polymer top coat layers. The polymer top coat 32 can include texturizing agents, such as silica, aluminum oxide, or glass particles, or other decorative additives such as a colorant, colored or metallic flakes, and glitter. The polymer top coat 32 can include polymer materials such as epoxies, polyureas, urethanes, acrylics, styrene-butadienes, polyvinyl acetates, chlorinated rubbers, polyesters, methacrylates, and combinations of these polymer materials. The polymer top coat 32 can have any thickness depending on the fiber thickness of the printed sheet, polymer material, and usage requirements. In one embodiment, the polymer top coat 32 has a thickness of about 10 to 250 mils.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A method of coating a substrate surface, comprising:
applying a polymer base coat on the substrate surface;
placing a printed sheet on at least a portion of the base coat; and
applying a polymer top coat on the printed sheet.

2. The method of claim 1, wherein the polymer base coat and the polymer top coat are applied as a liquid and further comprising curing each of the polymer base coat and the polymer top coat.

3. The method of claim 2, further comprising:
curing the polymer base coat;
applying an adhesive layer to the cured polymer base coat; and
placing the printed sheet on at least a portion of the adhesive layer.

4. The method of claim 3, wherein the polymer base coat is pigmented.

5. The method of claim 1, further comprising:
applying an adhesive layer on the polymer base coat;
placing a first sheet on at least a portion of the adhesive layer;
applying a second adhesive layer on the first sheet; and
placing a second sheet on at least a portion of the second adhesive layer;
wherein at least one of the first and second sheets is the printed sheet.

6. The method of claim 1, wherein the polymer base coat includes one of a neat polymer material and an aggregate filled polymer material, the polymer material selected from a group including epoxy, polyurea, urethane, acrylic, styrene-butadiene, polyvinyl acetate, chlorinated rubber, polyester, methacrylate, and combinations thereof.

7. The method of claim 1, wherein at least one of the polymer base coat and the polymer top coat includes an ultraviolet radiation resistant polymer material.

8. The method of claim 1, wherein the printed sheet is selected from a group consisting of natural fiber sheets, synthetic fiber sheets, vinyl sheets, fiberglass sheets, metal sheets, plastic sheets, holographic sheets, paper sheets, epoxy glass grid sheets, carbon fiber sheets, carbon fiber grids, and combinations thereof.

9. The method of claim 1, wherein the printed sheet is visible through the polymer top coat.

10. The method of claim 9, wherein the polymer top coat includes at least one polymer top coat layer including a polymer material selected from a group including epoxy, polyurea, urethane, acrylic, styrene-butadiene, polyvinyl acetate, chlorinated rubber, polyester, methacrylate, and combinations thereof.

11. The method of claim 1, wherein the substrate is selected from a group including concrete, wood, tile, metal, fiberglass, gypsum board, cement board, and drywall.

12. The method of claim 1, wherein the substrate is selected from a group including floors, walls, and ceilings.

13. A coated substrate surface obtained by the method of claim 1.

14. A method of coating a substrate surface, comprising:
applying a liquid polymer base coat to the substrate surface, the polymer base coat including a pigmented polymer material;
curing the polymer base coat;
applying an adhesive layer on at least a portion of the cured polymer base coat;
placing at least one printed sheet on at least a portion of the adhesive layer;
applying a polymer top coat including at least one liquid polymer top coat layer on the at least one printed sheet; and
curing the at least one liquid polymer top coat layer;
wherein the at least one printed sheet is visible through the polymer top coat.

15. The method of claim 14, wherein the printed sheet is one of a grid, perforated, and woven.

16. The method of claim 15, forming a monolithic bond of the adhesive layer through the printed sheet.

17. The method of claim 14, wherein the pigmented polymer material includes a polymer selected from a group including epoxy, polyurea, urethane, acrylic, styrene-butadiene, polyvinyl acetate, chlorinated rubber, polyester, methacrylate, and combinations thereof.

18. The method of claim 14, wherein the printed sheet is selected from a group consisting of natural fiber sheets, synthetic fiber sheets, vinyl sheets, fiberglass sheets, metal sheets, plastic sheets, holographic sheets, paper sheets, epoxy glass grid sheets, carbon fiber sheets, carbon fiber grids, and combinations thereof.

19. The method of claim 14, wherein each of the at least one polymer top coat layer includes a polymer material is selected from a group consisting of epoxy, polyurea, urethane, acrylic, styrene-butadiene, polyvinyl acetate, chlorinated rubber, polyester, methacrylate, and combinations thereof.

20. A multi-layered floor, comprising:
a floor substrate having a surface;
a polymer base coat bonded to the surface of the floor substrate;
a printed sheet bonded to a side of the polymer base coat opposite the surface of the floor substrate; and
a polymer top coat bonded to a side of the printed sheet opposite the polymer base coat;
wherein the printed sheet is visible through the polymer top coat.

21. The floor coating of claim 20, wherein the top coat includes a texturizing agent.

22. The floor coating of claim 20, wherein the top coat does not include a texturizing agent.

23. The floor coating of claim 20, wherein the polymer base coat includes a thickness of about 5 to 40 mils.

24. The floor coating of claim 20, wherein the polymer top coat includes a thickness of about 5 to 250 mils.

25. The floor coating of claim 20, wherein the floor coating is water impermeable and chemical resistant.
